(19) United States
(12) Patent Application Publication
(10) Pub. No.: US 2010/0023491 A1
(43) Pub. Date: Jan. 28, 2010

(54) METHOD AND APPARATUS FOR NETWORK STORAGE ACCESS RIGHTS MANAGEMENT

(76) Inventors: Cheng HUANG, Shenzhen (CN); Guojun Xu, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/571,485

(22) Filed: Oct. 1, 2009

Related U.S. Application Data
(63) Continuation of application No. PCT/CN2007/071365, filed on Dec. 28, 2007.

(30) Foreign Application Priority Data
Apr. 4, 2007 (CN) 200710091131.5

(51) Int. Cl. G06F 17/30

(52) U.S. Cl. 707/3; 707/9; 707/E17.014; 711/E12.091

(57) ABSTRACT

A method for network storage access rights management operates storage access rights of network storage directories or network storage files that an authorizing user sets for an authorized user. Authorization may be set for an authorized user in the network storage access rights metadata of the authorizing user according to the storage access rights information that the authorizing user requests to operate. Accordingly, the authorized user is allowed to access network storage locations of the authorizing user. A method for network storage access control and an apparatus for network storage access rights management are also provided.

This application is a continuation of International Application No. PCT/CN2007/071365, filed on Dec. 28, 2007, which claims priority to Chinese Patent Application No. 200710091131.5, filed on Apr. 4, 2007, both of which are hereby incorporated by reference in their entireties.

### TECHNICAL FIELD

The present disclosure relates to communications, and in particular, to a technology for network storage access rights management.

### BACKGROUND

The Open Mobile Alliance (OMA) is an international organization that formulates standards for mobile communication systems. The OMA proposes specifications for Session Initiation Protocol (SIP)-based messaging services such as Push to talk over Cellular (PoC), Instant Messaging (IM), and Call Protocol Message (CPM). The specifications implement messaging service storage through an OMA messaging system. The architecture of the OMA messaging system is shown in FIG. 1. The system includes a message content storage, a message metadata server, a message server, an aggregation proxy, a search proxy, and a core network. The message metadata server includes a network storage access controller and a messaging service metadata file manager.

The message content storage is responsible for managing and storing message files of messaging services that are actually received and sent by users during the use of messaging services. The messaging service includes history communication data such as messages, session records, and the multimedia data files that may be stored in the message content storage.

The message metadata server is responsible for storing and managing configuration information of user messaging services and metadata information for describing the user messaging services. The configuration information of the user messaging services includes messaging service settings, such as contact lists, predefined groups, and user access policies. The metadata information for description includes metadata for describing offline messages and history communication data of sessions, where the metadata is stored in media files such as messaging service metadata files.

The messaging service metadata file manager in the message metadata server is responsible for managing media files thereof such as messaging service metadata files, where each messaging service metadata file stores configuration information and metadata information of messaging services.

The network storage access controller in the message metadata data server is configured to control access rights according to the data in media files managed by the messaging service metadata file manager.

The message server is responsible for controlling logics of messaging services; that is, it controls the message content storage in storing and managing messaging services, and controls the message metadata server in storing and managing the configuration information of user messaging services.

The aggregation proxy is a proxy on a network through which users can access message metadata. It is responsible for authenticating an authorizing client that owns rights to manage the message metadata and routing a network storage access request to a proper network entity, such as the message metadata server and search proxy.

The search proxy is configured to: receive a message metadata search request that the client sends through the aggregation proxy, and send the request to a proper message metadata storage entity, such as the message metadata server. The search proxy is further configured to: integrate received search results in a search response, and return the search results to the client through the aggregation proxy.

When the client accesses the recorded messaging services, it first accesses metadata information of messaging services recorded in the message metadata server through the aggregation proxy; then, it accesses contents of the messaging services in the message content storage through interaction with the message server via the core network.

Currently, when the message metadata server records the metadata information of user messaging services, it classifies all the metadata information of the same user according to application usage; that is, it categorizes the metadata in the same Application Usage (AU) into one type; then, the message metadata server organizes all the metadata information of messaging services of the user according to a directory structure of “Extensible Markup Language (XML) documents directory” metadata files. FIG. 2 shows a logical structure of the directory. The XML documents directory includes a root node <xcap-directory>, a child node <folder> in the root node, and a child node <entry> in the child node <folder>.

The root node <xcap-directory> represents the root directory for metadata information of all the messaging services of a user. Each child node <folder> in the root node is associated with all the metadata information of a specific messaging service of the user in the same AU Identification (AUID). The child node <entry> points to a specific messaging service metadata file, for example, four types of messaging service metadata files shown in FIG. 2: deferred-list, cpm-rules, history-list, and index.

After the message metadata server organizes all the metadata information of a user, it stores the XML documents directory in a storage space reserved for the user so that the user may access the network storages according to the metadata information of the network storages, including network storage metadata and/or network storage messaging services.

Messaging services as previously described, may exhibit deficiencies because a user owning network storages can only access his/her own network storages according to the metadata information in his/her own XML documents directory. Further, the user may forbid other users from accessing his/her network storages.

### SUMMARY

Disclosed embodiments provide a method and apparatus for network storage access rights management, and a method for network storage access control so that other users can access network storages of users who own the network storages. Consistent with some embodiments, the users who owns the network storages are called authorizing users, and users who can access the network storages of the users owning the network storages are called authorized users.

The disclosed embodiments provide a method for network storage access rights management. The method may include:

obtaining a request for operating network storage access rights from an authorizing user, where the request carries the storage access rights information that the authorizing user requests to operate; and

operating storage access rights of network storage directories or network storage files that the authorizing user sets for an authorized user in network storage access rights metadata of the authorizing user according to the storage access rights information that the authorizing user requests to operate.

A method for network storage access control is provided. The method may include:

obtaining a request for accessing network storages of an authorizing user from an authorized user; and

providing the authorized user with metadata accessible to the authorized user in network storage metadata files of the authorizing user according to storage access rights information of the authorized user in the network storage access rights metadata of the authorizing user.

An apparatus for network storage access rights management is provided. The apparatus may include a network storage access controller and a messaging service metadata file manager, where:

the network storage access controller is configured to: obtain a request for operating network storage access rights from an authorizing user, where the request carries the storage access rights information that the authorizing user requests to operate, and authenticate the request for operating network storage access rights from the authorizing user according to the storage access rights information in the messaging service metadata file manager; and

the messaging service metadata file manager is configured to: based on the request for operating network storage access rights authenticated by the network storage access controller, operate storage access rights of network storage directories or network storage files that the authorizing user sets for an authorized user in the network storage access rights metadata of the authorizing user according to the storage access rights information that the authorizing user requests to operate.

Another apparatus for network storage access rights management is provided. The apparatus may include a network storage access controller and a messaging service metadata file manager, where:

the network storage access controller is configured to: obtain a request for accessing network storages of an authorizing user from an authorized user; authenticate the access request of the authorized user according to storage access rights information of the authorized user in network storage access rights metadata of the authorizing user in the messaging service metadata file manager; request metadata accessible to the authorized user from the messaging service metadata file manager if the authentication succeeds, and provide the authorized user with metadata returned by the messaging service metadata file manager; and

the messaging service metadata file manager is configured to return the storage access rights information of the authorized user in the network storage access rights metadata of the authorizing user to the network storage access controller.

Consistent with some embodiments, the storage access rights of network storage directories or network storage files that the authorizing user sets for the authorized user may be operated in the network storage access rights metadata of the authorizing user according to the storage access rights information that the authorizing user requests to operate, so that the authorized user has the rights to access the network storages of the authorizing user.

### BRIEF DESCRIPTION OF THE DRAWINGS

FIG. 1 shows the architecture of an OMA messaging system provided in the prior art;

FIG. 2 shows a logical structure of a directory of “XML documents directory” metadata files in the prior art;

FIG. 3 shows a logical structure of a directory of “XML documents directory” metadata files in a first embodiment;

FIG. 4 is a flowchart of the first embodiment;

FIG. 5 shows a logical structure of a directory for messaging service metadata of storage authorization policy application usage in the first embodiment

FIG. 6 shows a logical structure of a directory for user access control information of user access policy application usage in the first embodiment;

FIG. 7 is a flowchart of granting, changing and withdrawing network storage access rights based on a storage authorization policy scheme in the first embodiment;

FIG. 8 is a flowchart of a first scheme for notifying changed network storage access rights in the first embodiment;

FIG. 9 is a flowchart of a second scheme for notifying changed network storage access rights in the first embodiment;

FIG. 10 is a flowchart of a third scheme for notifying changed network storage access rights in the first embodiment;

FIG. 11 is a flowchart of a fourth scheme for notifying changed network storage access rights in the first embodiment;

FIG. 12 is a flowchart of a second embodiment;

FIG. 13 is a flowchart of authenticating a request for accessing network storage metadata by an authorizing user in the second embodiment;

FIG. 14 is a flowchart of controlling the access of an authorized user with read/write rights consistent with some embodiments;

FIG. 15 is a structural diagram of an apparatus provided in a third embodiment; and

FIG. 16 is a structural diagram of an apparatus provided in a fourth embodiment.

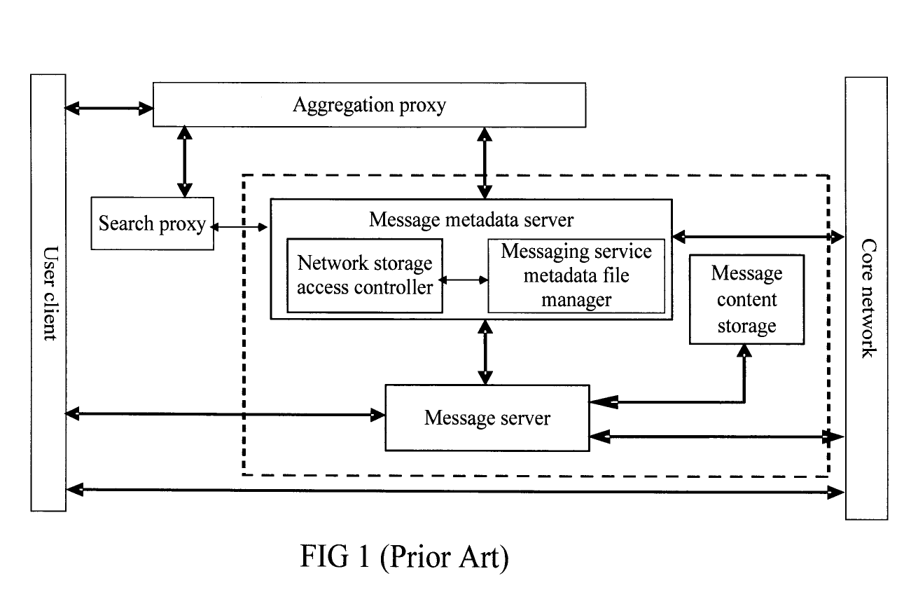

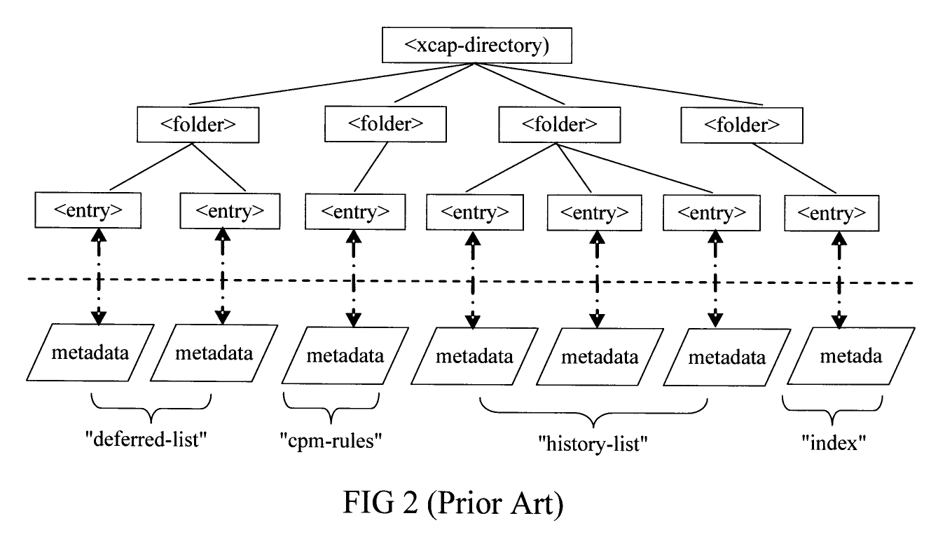

### DETAILED DESCRIPTION

The first embodiment provides a method for network storage access rights management. For implementation of the first embodiment, the metadata information of messaging services in a same AU of a user may be classified according to attributes of the messaging services; a network storage directory needs to be created for each type of metadata; and the association between the network storage directory and the network storage metadata files (or media files) storing the metadata is established. Thus, the first embodiment may overcome the weakness of a messaging system, in which the messaging system classifies metadata information of all the messaging services of a user according to the AU and cannot organize the metadata in an AU by level of metadata.

The attributes of messaging services may include a subject attribute (also called the subject attribute) and execution time attribute of a messaging service (also called the date attribute) in a same AU. The metadata of all the messaging services in a same AU of a same user may be classified according to the attributes of the messaging services. That is, the metadata of messaging services with the same attribute is classified into a type, and thus deriving different types of metadata. Then, a network storage directory may be created for each type of metadata, and an association is established between the network storage directory and the network storage metadata files storing the metadata. Each type of metadata may be further classified to derive next-level metadata of the type, and a next-level network storage directory may be created for the next-level metadata.

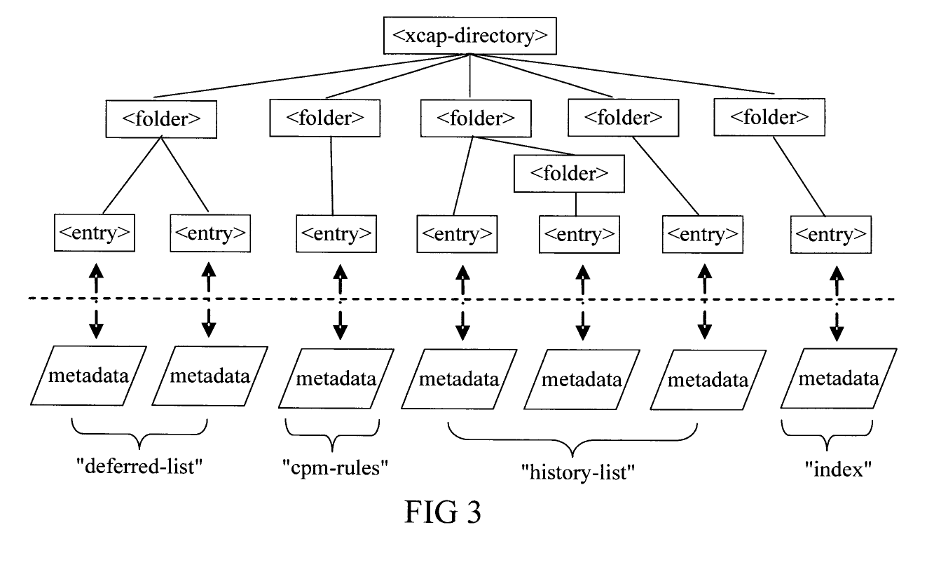

The metadata of messaging services of the user may be organized according to the structure of a network storage directory defined in the “XML documents directory” metadata files. FIG. 3 shows the logical structure of a network storage directory. As shown in FIG. 3, the network storage directory may include a <xcap-directory> root node, <folder> child nodes in the root node, a <folder> child node in the <folder> child nodes of the root node, and <entry> child nodes. It should be noted that each child node in the structure is associated with each element. For example, the <folder> child node is associated with the <folder> element.

The <xcap-directory> root node represents the root directory for the metadata information associated with all the messaging services of a user. The <folder> child nodes in the root directory represent network storage directories for metadata associated with different attributes of messaging services in the same AU. The <folder> child node in the <folder> child nodes of the root directory represents a network storage directory for metadata after the metadata of the network storage directories represented by the upper-level <folder> child nodes is further classified according to the attributes of the messaging services. The <entry> nodes represent network storage metadata files that store the metadata.

Each <folder> child node carries a unique ID and attributes of the network storage directory, for example, subject attribute information. The <entry> child node that represents a file storing the metadata in each <folder> child node also carries a unique ID and a URI that links a specific messaging service metadata file.

For clarity, the network storage metadata files (also called media files) that store metadata and message files that store messaging service contents are collectively called network storage files in this embodiment.

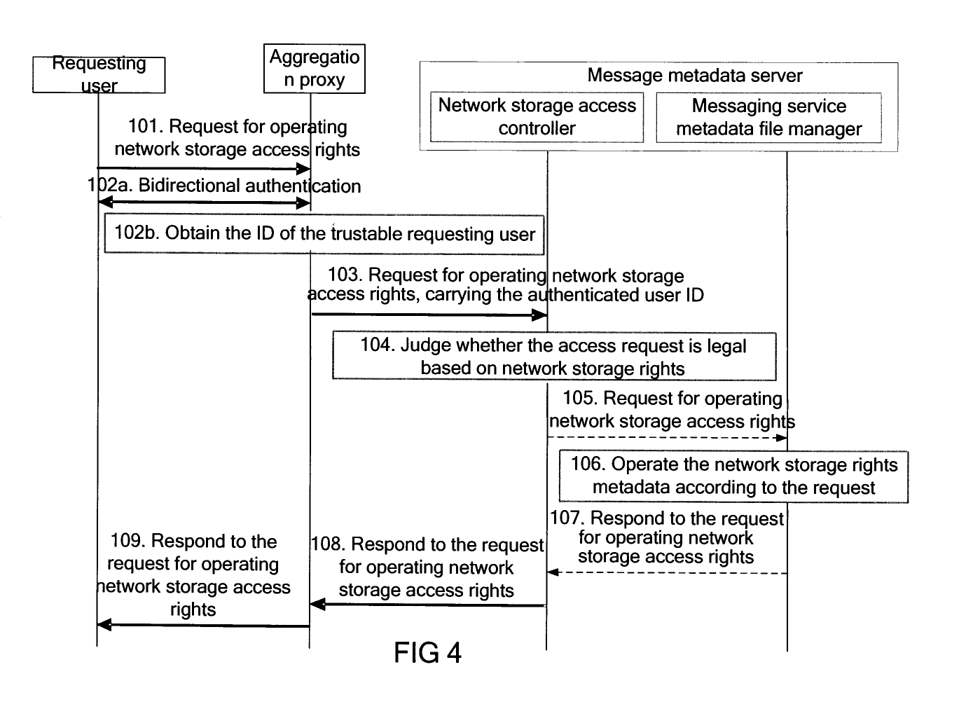

To allow other authorized users to access network storages of an authorizing user, the authorizing user may manage the network storage rights for metadata of his/her network storage directories or network storage metadata files in the message metadata server, so that the authorizing user can control the access rights of other authorized users. FIG. 4 shows a specific implementation process consistent with the first embodiment. The process may includes the following steps:

S101. The requesting user sends a request for operating network storage access rights, where the request carries the storage access rights information of the authorized users that the authorizing user requests to operate.

The storage access rights information of the authorized users that the authorizing user requests to operate may include:

ID of the authorizing user, ID of at least one authorized user and related information of network storage directories or network storage files involved in the storage access rights information. The related information of network storage directories or network storage files may be IDs of the network storage directories or network storage files.

The storage access rights information of the authorized users that the authorizing user requests to operate may include the ID of the authorizing user, ID of at least one user who is forbidden to obtain access rights and related information of network storage directories or network storage files involved in the storage access rights information. The related information of network storage directories or network storage files may be IDs of the network storage directories or network storage files.

The ID of at least one authorized user and ID of at least one user who is forbidden to obtain access rights correspond to a white list and a black list, which may be carried in a stored user list separately or simultaneously. This embodiment supposes that the storage access rights information of the authorized user that the authorizing user requests to operate includes the ID of at least one authorized user.

In addition, the storage access rights information of the authorized user that the authorizing user requests to operate may further include an access type, an expiration date, or a granting date.

The access type may include access rights of the network storage files or network storage directories, inheritance attributes of the access rights of the network storage files or network storage directories, and lock attributes of the access rights of the network storage files or network storage directories.

The access rights of the network storage files or network storage directories may include Full Control, Modify, List Folder Content, Read, Write, and priority of the access rights of the network storage files or network storage directories.

Full Control indicates that the rights are owned by the authorizing user only. That is, only the authorizing user can operate (grant, change and withdraw) rights of files and directories.

The priority of file or directory access rights required in the access request of a requesting user must be lower than or equal to that of the file or directory rights owned by the user. For a same file or directory of the requesting user, the high priority covers the low priority.

The inheritance attributes of the rights may affect the rights to access files and directories. If the inheritance right is set for a directory, new files and subfolders in the directory will inherit these rights by default.

The lock attributes of the rights may determine whether a requesting user is allowed to view files or directories. If the lock attribute of a right for a file or directory is set to TRUE, the user is forbidden to view the rights information of the file or directory.

S102a-S102b. The aggregation proxy and authorizing user perform bidirectional authentication according to the ID of the requesting user carried in the request. After the authentication succeeds, the aggregation proxy obtains the ID of the trustable requesting user.

The aggregation proxy sends a challenge to the received initial request by using local security policies, for example, Hypertext Transfer Protocol (HTTP) digital digest (HTTP digest). Then, the aggregation proxy obtains the ID of the trustable requesting user according to the feedback of the authorizing user, unauthorized failure response or authentication success.

S103. The aggregation proxy forwards the request for operating network storage access rights to the message metadata server, where the request carries the storage access rights information of the authorized user that the requesting user requests to operate. The storage access rights information of the authorized user that the authorizing user requests to operate may include the ID of the authenticated requesting user, related information of network storage directories or network storage files involved in the storage access rights (for example, IDs of network storage directories or network storage files), and the ID of the authorized user.

S104. After the request for operating network storage access rights reaches the message metadata server, the message metadata server judges whether the requesting user is the authorizing user through a network storage access controller according to the ID of the authorizing user and ID of the requesting user in a resource access path that is associated with the related information of network storage directories or network storage files carried in the request. If the requesting user is not the authorizing user, the message metadata server rejects the request. Otherwise, the message metadata server regards the requesting user as a legal user and accepts the request.

In this step, the network storage access controller judges whether the requesting user is the authorizing user by comparing the ID of the requesting user with the ID of the authorizing user in the resource access path that is associated with the related information of network storage directories or network storage files carried in the request. If the ID of the requesting user is the same as the ID of the authorizing user, the requesting user is the legal authorizing user. Otherwise, the requesting user is an illegal user.

S105. The network storage access controller sends the request for operating network storage access rights to a messaging service metadata file manager in the message metadata server. The request carries the storage access rights information of the requesting user that the requesting user requests to operate. The storage access rights information of the requesting user that the requesting user requests to operate includes the ID of the requesting user, IDs of network storage directories or network storage files involved in the access rights, and the ID of the authorized user.

S106. After receiving the request for operating network storage access rights, the messaging service metadata file manager searches for the network storage access rights metadata file of the messaging services associated with the ID of the requesting user according to the ID of the requesting user and related information of network storage metadata directories or network storage files.

In the network storage access rights metadata file, the storage access rights metadata associated with the ID of the authorized user may be operated according to the storage access rights information carried in the request of the requesting user. This may be implemented, for example, by using the following two methods:

(1) Operation method based on a storage authorization policy: This method enables the authorizing user to manage his/her network storage rights (for example, grant, change and withdraw rights) by using the messaging service metadata of the “storage authorization policy” AU provided in some embodiments. The messaging service metadata includes information about certain access control and storage access rights. The access control information includes the ID of the requesting user and ID of messaging service metadata involved in the network storage access rights. The storage access rights information includes the access type, granting date, and expiration date, which are listed in S101.

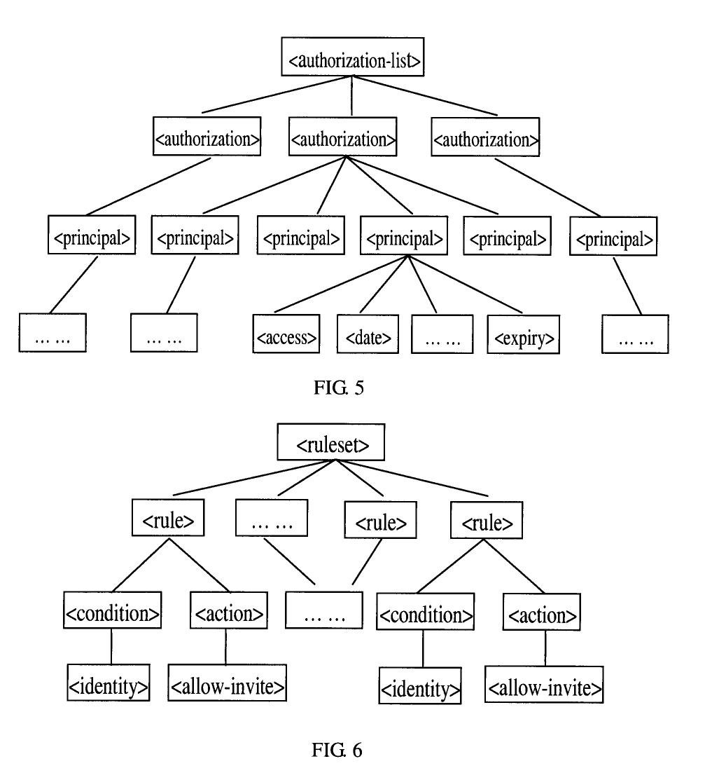

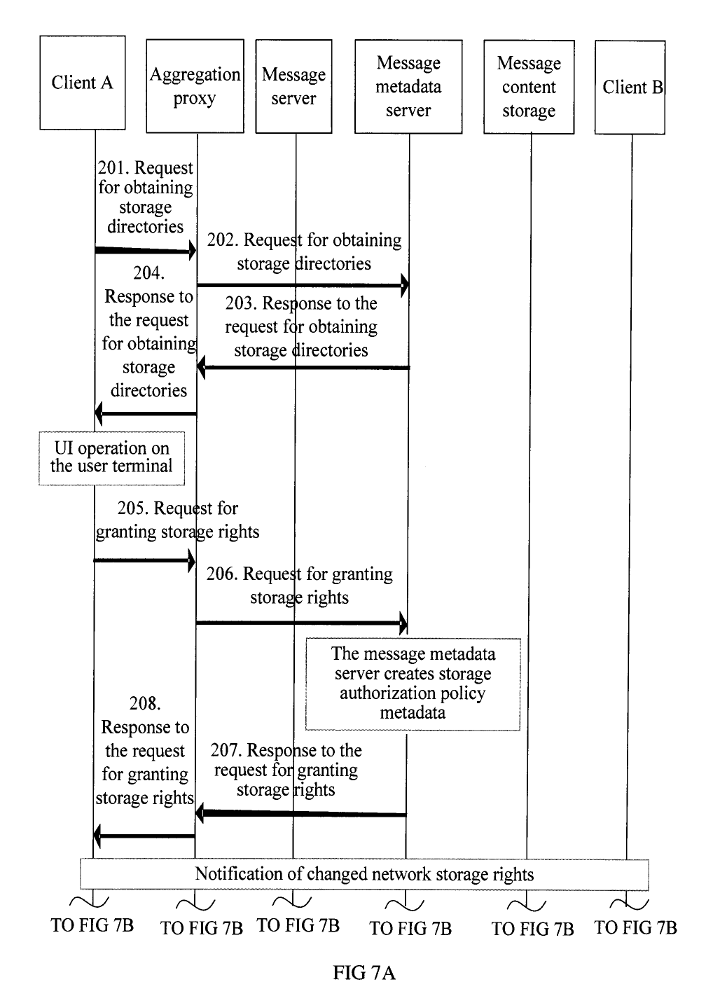

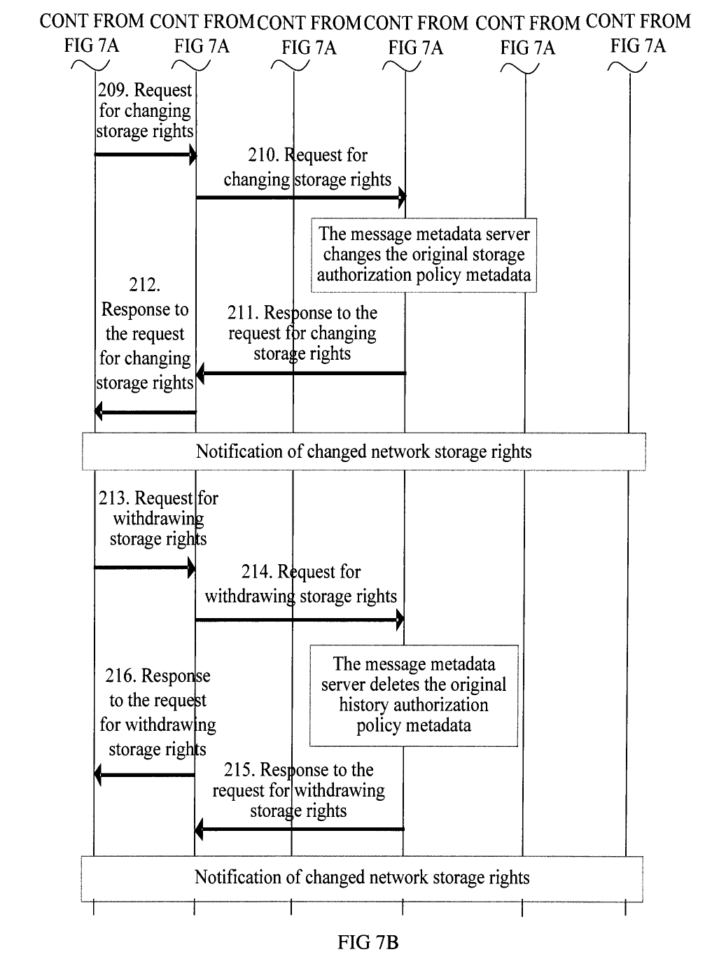

The messaging service metadata of the “storage authorization policy” AU may be stored as a storage authorization policy metadata file in a directory shown in FIG. 5.

In FIG. 5, the <authorization> element represents the storage authorization policy for a network storage directory or network storage file of the authorizing user, which is allocated a globally unique ID of the authorizing user associated with the network storage directory or network storage file; the <principal> child element in the <authorization> element represents the storage access rights metadata associated with an authorized user that is created in the storage authorization policy <authorization>; the <principal> element of the storage access rights metadata includes a URI of an authorized user B, an access type <access> child element, a granting date <date> child element, and an expiration date <expiry> child element.

Based on the preceding structure of a storage authorization policy metadata file, when the storage access rights metadata associated with the ID of the requesting user is operated, the following operations may be performed: create storage access rights information associated with the ID of the authorized user in the storage authorization policy metadata file associated with the ID of the authorizing user according to the storage access rights information of the requesting user carried in the request; or update storage access rights information associated with the ID of the authorized user in the storage authorization policy metadata file associated with the ID of the authorizing user according to the storage access rights information of the requesting user carried in the request; or delete the storage access rights information associated with the ID of the authorized user in the storage authorization policy metadata file associated with the ID of the authorizing user according to the storage access rights information of the requesting user carried in the request.

(2) Operation method based on a user access policy: This method separates the access control information from the storage access rights information. It defines user network storage access control rules by using the user access policy AU metadata that is already adopted by the OMA standard, and implements network storage access control based on customized rules of the authorizing user. The specific storage access rights information is stored in the metadata files of network storage directories or network storage files of the authorizing user that are associated with the network storage access control rules.

FIG. 6 shows a logical structure of the preceding user access policy metadata file, in which a <rule> element is used to define the user access control information or is applicable to the access control information of a whole network storage directory represented by a <folder> element in the XML documents directory metadata or is used only for the access control information of messages, session records and multimedia data files stored in a network storage directory represented by an <entry> element. This embodiment judges whether the access control information is in the <folder> element or in the <entry> element by comparing the relation between the unique IDs of the <rule>, <folder>, and <entry> elements. Further, elements <conditions> and <actions> may also be defined in the <rule> element to correspond to access conditions and actions of the <folder> element or <entry> element.

When the storage access rights metadata associated with the ID of the requesting user is operated based on the user access policy metadata file, the following operations may be performed: create network storage access control rules associated with the ID of the authorized user in the preceding user access policy metadata file associated with the ID of the authorizing user, and create storage access rights information associated with the ID of the authorized user in network storage directories or network storage files of the authorizing user that are associated with the network storage access control rules according to the storage access rights information carried in the request; or change the storage access rights information associated with the ID of the authorized user in the metadata files of network storage directories or network storage files of the authorizing user that are associated with the network storage access control rules according to the storage access rights information carried in the request; or delete the network storage access control rules associated with the ID of the authorized user in the user access policy metadata file associated with the ID of the authorizing user, and delete the storage access rights information associated with the ID of the authorized user in the metadata files of network storage directories or network storage files of the authorizing user that are associated with the network storage access control rules according to the storage access rights information carried in the request.

S107-S109. Return a response for operating network storage rights.

The preceding request for operating network storage access rights may include the following types of requests: request for granting network storage access rights, request for changing network storage access rights, and request for withdrawing network storage access rights.

The following describes how the preceding types of requests are implemented with reference to the storage authorization policy in S106 of the first embodiment.

S201-S204. An authorizing user A (client A) sends a request (XCAP GET) for obtaining the network storage directory structure to the message metadata server through the aggregation proxy. The message metadata server returns the metadata of network storage directories and network storage metadata files of the user A to the authorizing user A according to the request.

S205-S206. After obtaining the metadata of network storage directories and network storage metadata files, the authorizing user A may browse the network storage directories through a terminal device, view messaging service metadata in a directory, select network storage directories metadata or network storage files metadata for authorizing the user B, and set a specific access right. Then, the authorizing user A sends a request (XCAP PUT) for granting network storage access rights to the message metadata server through the aggregation proxy, where the request carries the network storage access rights that the authorizing user A requests to grant to the user B. The network storage access rights include the ID of the authorizing user A, IDs of network storage directories or network storage files involved in the access rights, and the ID of the authorized user B.

S207-S209. The network storage access controller in the message metadata server sends a request for operating network storage rights of the authorizing user A to the messaging service metadata file manager according to the ID of the authorizing user A in the request, where the request carries the storage access rights information of the authorized user B and IDs of network storage directories or network storage files involved in the access rights.

After receiving the request, the messaging service metadata file manager searches the storage authorization policy metadata file (as shown in FIG. 5) of the authorizing user A for storage authorization policy metadata (namely, the <authorization> element in FIG. 5) associated with the IDs of network storage directories or files carried in the request. If no storage authorization policy metadata is available, the messaging service metadata file manager creates an <authorization> element that represents a storage authorization policy for a network storage directory or file, and allocates a globally unique ID of the user A that is associated with the network storage directory or file to the storage authorization policy. In addition, the messaging service metadata file manager creates storage access rights metadata (namely, the <principal> element in FIG. 5) associated with the network storage access rights that are granted to the user B in the request for the <authorization> metadata of the new storage authorization policy, where the <principal> element of the storage access rights metadata includes a URI of the authorized user B, an access type <access> child element, a granting date <date> child element, and an expiration date <expiry> child element.

If the storage authorization policy <authorization> metadata associated with the IDs of network storage directories or network storage metadata files carried in the request is already available in the storage authorization policy metadata file of the authorizing user A, the messaging service metadata file manager directly creates a piece of storage access right <principal> metadata associated with the network storage access rights that are granted to the user B in the request for the storage authorization policy metadata.

The messaging service metadata file manager returns a success response to the network storage access controller only after finishing all the preceding steps; otherwise the messaging service metadata file manager returns a failure response.

The message metadata server returns a response to the client of the user A through the aggregation proxy.

S210. After the message metadata server creates the storage authorization policy, the requesting user B receives a notification of network storage access rights, where the notification includes IDs of network storage directories authorized by the authorizing user A and rights information thereof. The following describes several optional processes of receiving the notification by the user B after the network storage access rights are changed.

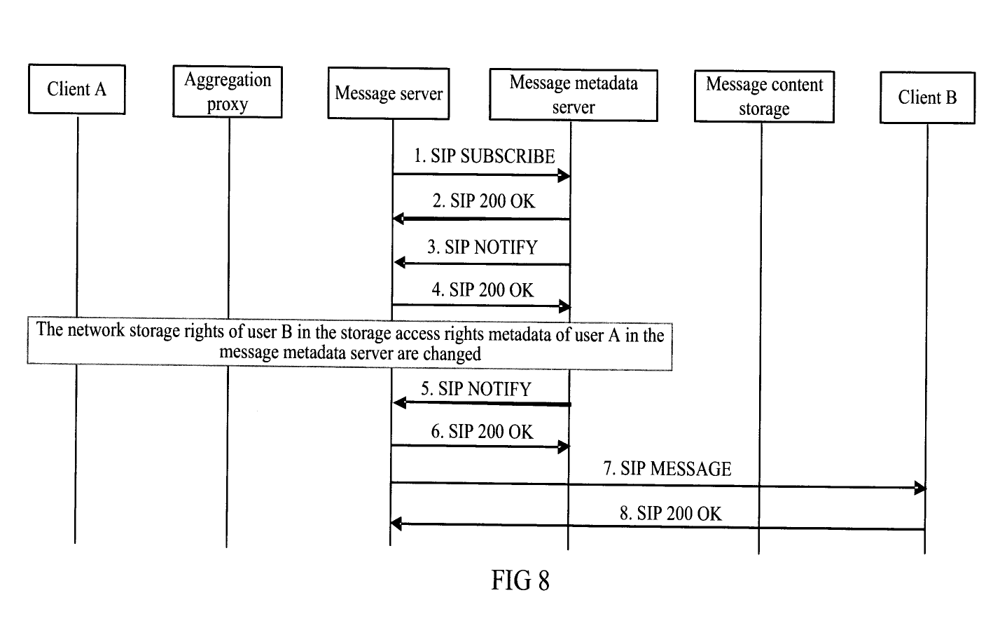

First mode: The message server obtains the changed network storage access rights metadata by subscribing to the notification of network storage access rights in the message metadata server, and notifies the authorized user associated with the network storage access rights metadata of the changed network storage access rights metadata. As shown in FIG. 8, the process includes the following steps:

S1-S4. The message server sends a SIP SUBSCRIBE message for subscribing to the notification of the status change of storage access rights metadata associated with the authorizing user A in the message metadata server.

S5-S6. Once the authorizing user A operates network storage rights or a network storage right is automatically withdrawn due to expiration, which changes authorization information status of the user B in the storage access rights metadata that is associated with the authorizing user A in the message metadata server, the message metadata server sends a SIP NOTIFY message to the message server, where the notification carries the changed network storage rights of the user B.

S7-S8. The message server sends a SIP MESSAGE to the user B, notifying the user B of changed network storage rights.

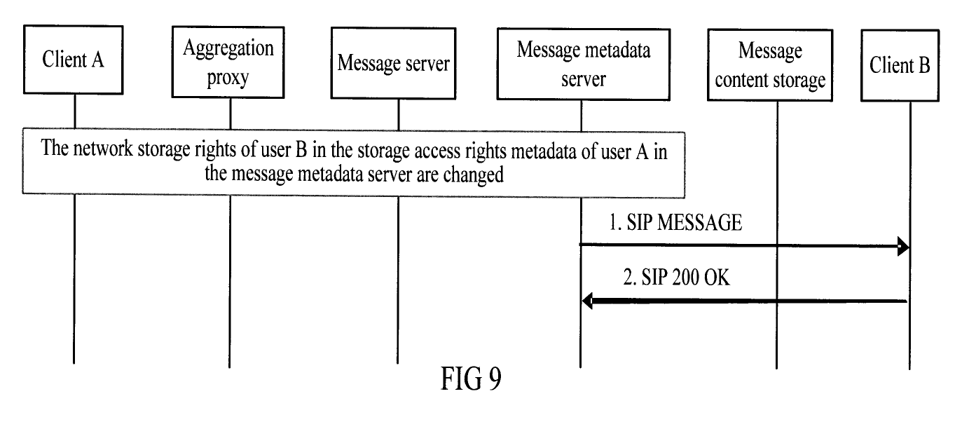

Second mode: After finding that the network storage access rights are changed, the message metadata server notifies the authorized user associated with the network storage access rights metadata of changed network storage access rights metadata. As shown in FIG. 9, the process includes the following steps:

S1. Once the authorizing user A operates network storage rights or a network storage right is automatically withdrawn due to expiration, which changes authorization information status of the user B in the storage access rights metadata that is associated with the authorizing user A in the message metadata server, the message metadata server sends a SIP MESSAGE notification to the user B, where the notification carries the changed network storage rights of the user B.

S2. The requesting user B returns a response to the message metadata server.

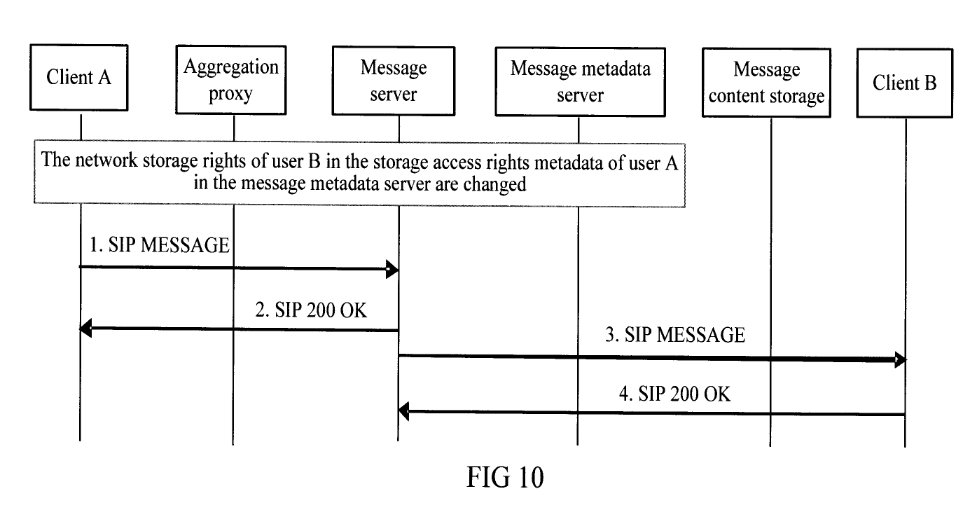

Third mode: After operating network storage access rights, the authorizing user notifies the authorized user associated with the network storage access rights metadata of changed network storage access rights through the message server. As shown in FIG. 10, the process includes the following steps:

S1-S2. Once the authorizing user A operates network storage rights, which changes the authorization information status of the user B in the storage access rights metadata associated with the authorizing user A in the message metadata server, the authorizing user A sends a SIP MESSAGE notification to the message server, where the notification carries the changed network storage rights of the user B.

S3-S4. The message server forwards the SIP MESSAGE to the user B.

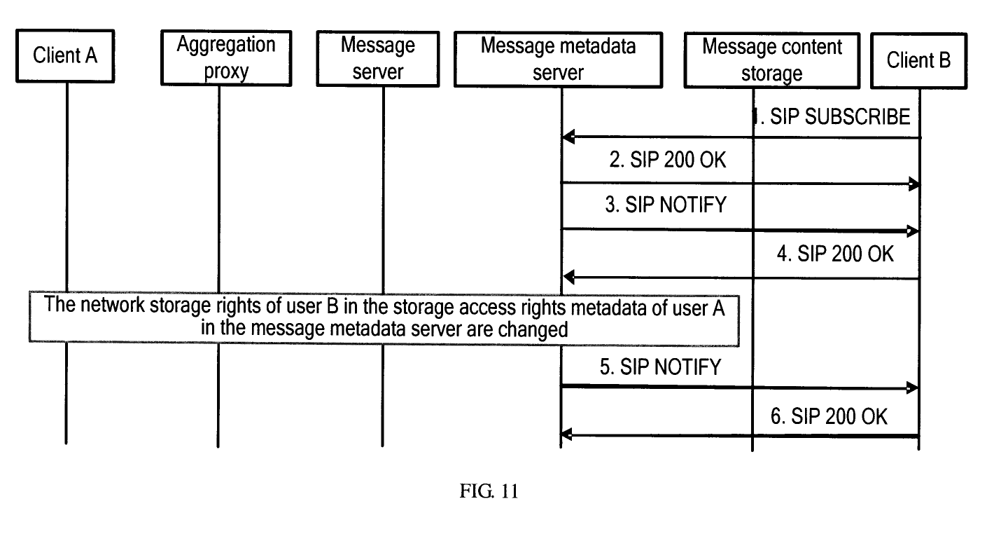

Fourth mode: The user B subscribes to the notification of network storage access rights in the message metadata server. After the network storage access rights are changed, the message metadata server notifies the authorized user associated with the network storage access rights metadata of changed network storage access rights. As shown in FIG. 11, the process includes the following steps:

S1-S4. The user B sends a SIP SUBSCRIBE message for subscribing to the notification of the status change of storage access rights metadata associated with the authorizing user A in the message metadata server.

S5-S6. Once the authorizing user A operates network storage rights or a network storage right is automatically withdrawn due to expiration, which changes authorization information status of the user B in the storage access rights metadata that is associated with the authorizing A in the message metadata server, the message metadata server sends a SIP NOTIFY notification to the user B, where the notification carries the changed network storage rights of the user B.

What has been described above is a process of granting network storage access rights to the requesting user. The process of updating network storage access rights includes the following steps:

S211-S212. The authorizing user A may request to update network storage access rights granted to the user B. To do this, the user A browses rights of network storage directories or network storage files that are already granted to the user B, and resets the access rights; the user A sends a request (XCAP PUT) for updating network storage access rights to the message metadata server through the aggregation proxy, where the request carries the ID of the user A, network storage access rights of the user B to be updated, and IDs of network storage directories or network storage files involved in the access rights.

The network storage access controller in the message metadata server sends a request for operating network storage rights of the authorizing user A to the messaging service metadata file manager according to the ID of the authorizing user A in the request, where the request carries storage access rights information of the user B to be updated. The network storage access rights information includes the ID of the authorizing user A, related information of network storage directories or network storage files involved in the access rights, and the ID of the user B.

After receiving the request, the messaging service metadata file manager searches the storage authorization policy metadata file of the authorizing user A for the authorization policy metadata <authorization> element associated with related information of network storage directories or network storage metadata files in the request, and changes the <principal> element that represents the storage access rights metadata associated with the ID of the authorized user in the authorization policy metadata <authorization> element.

After the message metadata server changes the storage authorization policy metadata, the user B receives a notification of changed network storage access rights, where the notification includes IDs of changed network directories or network storage files of the authorizing user A and related network storage rights information. After the network storage access rights are changed, the mode of receiving a notification by the user B may be implemented by using the preceding optional processes, which will not be further described.

To withdraw network storage access rights that are already granted to the user B, the authorizing user A may take the following steps:

S213-S216. The authorizing user A may also request to withdraw the network storage access rights that are already granted to the user B. To do this, the user A browses the rights of network storage directories or network storage files that are already granted to the user B, and withdraws some access rights selectively. Then, the user A sends a request (XCAP DELETE) for withdrawing network storage access rights to the message metadata server through the aggregation proxy, where the request carries the network storage access rights of the user B to be withdrawn. The network storage access rights include the ID of the user A, IDs of network storage directories or network storage files involved in the access rights, and the ID of the user B.

The network storage access controller in the message metadata server sends a request for operating network storage rights of the authorizing user A to the messaging service metadata file manager according to the ID of the authorizing user A in the request, where the request carries storage access rights of the user B to be withdrawn. The network storage access rights information includes the ID of the user A, related information of network storage directories or network storage files involved in the access rights, and the ID of the user B.

After receiving the request, the messaging service metadata file manager searches the storage authorization policy metadata file of the authorizing user A for the authorization policy metadata <authorization> element associated with related information of network storage directories or network storage metadata files in the request, and deletes the <principal> element that represents the storage access rights metadata associated with the ID of the authorized user in the authorization policy metadata <authorization> element according to the storage access rights of the user B to be withdrawn in the request.

After the message metadata server deletes the storage authorization policy, the user B receives a notification of changed network storage access rights, where the notification includes IDs of network storage directories withdrawn by the authorizing user A and rights information thereof. After the network storage access rights are changed, the mode of receiving a notification by the user B may be implemented by using the preceding optional processes, which will not be further described.

The implementations of the preceding types of requests for operating storage access rights have been described with reference to the storage authorization policy in S106 in the first embodiment. The following describes how to operate network storage access rights with reference to the user access policy in S106 in the first embodiment.

I. Granting Network Storage Access Rights

The network storage access controller in the message metadata server sends a request for granting network storage rights of the authorizing user A to the messaging service metadata file manager according to the ID of the authorizing user A carried in the request, where the request carries storage access rights of the user B to be granted. The network storage access rights information may include the ID of the authorizing user A, related information of network storage directories or network storage files involved in the access rights, and the ID of the authorized user B.

After receiving the request, the messaging service metadata file manager searches the user access policy metadata file (as shown in FIG. 6) of the authorizing user A for access rule metadata (namely, the <rule> element> in FIG. 6) associated with the IDs of network storage directories or network storage metadata files carried in the request. If no access rule metadata is available, the messaging service metadata file manager creates a <rule> element that represents the access rule metadata of a network storage directory or network storage metadata file in the request, and allocates a globally unique ID of the authorizing user A associated with the network storage directory or network storage metadata file. In addition, the messaging service metadata file manager adds the URI of the user B to the <condition> child element that represents access control conditions in the <rule> element, and sets the value of the <allow-invite> element in the <action> child element that represents access actions in the <rule> element to “accept”, which indicates that the user B is allowed to access the network storage directory or network storage file of the user A associated with the access control rule.

If the <rule> element that represents the access rule metadata associated with the ID of the network storage directory or network storage metadata file carried in the request is already available in the user access policy metadata file of the authorizing user A, the messaging service metadata file manager performs the same operation on the access rule metadata directly.

In addition, the messaging service metadata file manager locates a network storage metadata file (for example, a “session history” metadata file) of the authorizing user A associated with the preceding access rule according to the ID of the network storage directory or network storage file carried in the request. Then, the messaging service metadata file manager creates storage access rights metadata associated with the network storage rights that are granted to the user B carried in the request in the network storage metadata file involved in the authorization request. The metadata includes a URI of the user B, an access type <access> child element, a granting date <date> child element, and an expiration date <expiry> child element.

The messaging service metadata file manager returns a success response to the network storage access controller only after finishing all the preceding steps; otherwise the messaging service metadata file manager returns a failure response.

II. Updating Network Storage Access Rights

The network storage access controller in the message metadata server sends a request for updating network storage rights of the authorizing user A to the messaging service metadata file manager according to the ID of the authorizing user A carried in the request, where the request carries storage access rights information of the user B to be updated. The network storage access rights information includes the ID of the authorizing user A, related information of network storage directories or network storage files involved in the access rights, and the ID of the authorized user B.

After receiving the request, the messaging service metadata file manager searches the user access policy metadata file of the authorizing user A for access rule metadata (namely, the <rule> element> in FIG. 6) associated with the IDs of network storage directories or network storage metadata files carried in the request, and locates network storage metadata files (for example, the “session history” metadata file) of the authorizing user A associated with the preceding access rule according to the IDs of network storage directories or network storage metadata files carried in the request. Then, the messaging service metadata file manager updates the storage access rights metadata associated with the ID of the user B according to the storage access rights information of the user B to be updated in the network storage metadata files involved in the update request.

III. Withdrawing Network Storage Access Rights

The network storage access controller in the message metadata server sends a request for withdrawing network storage rights of the authorizing user A to the messaging service metadata file manager according to the ID of the authorizing user A carried in the request, where the request carries storage access rights of the user B to be withdrawn. The network storage access rights information includes the ID of the authorizing user A, related information of network storage directories or network storage files involved in the access rights, and the ID of the authorized user B.

The messaging service metadata file manager searches the user access policy metadata file of the authorizing user A for access rule metadata (namely, the <rule> element> in FIG. 6) associated with related information of network storage directories or network storage files according to the ID of the authorizing user A carried in the request, and deletes the ID of the user B in the <condition> child element of the <rule> element. In addition, the messaging service metadata file manager locates network storage metadata files (for example, the “session history” metadata file) of the authorizing user A associated with the preceding access rule according to the IDs of network storage directories or network storage metadata files carried in the request. Then, the messaging service metadata file manager deletes the storage access rights metadata associated with the ID of the user B according to the storage access rights of the user B to be withdrawn in the network storage metadata files involved in the withdrawing request.

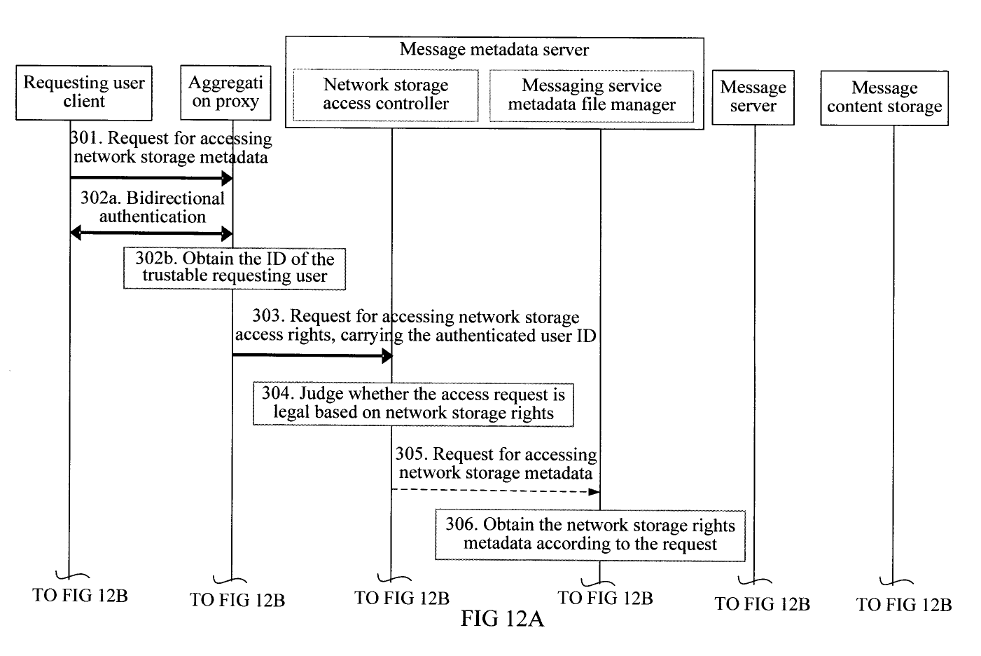

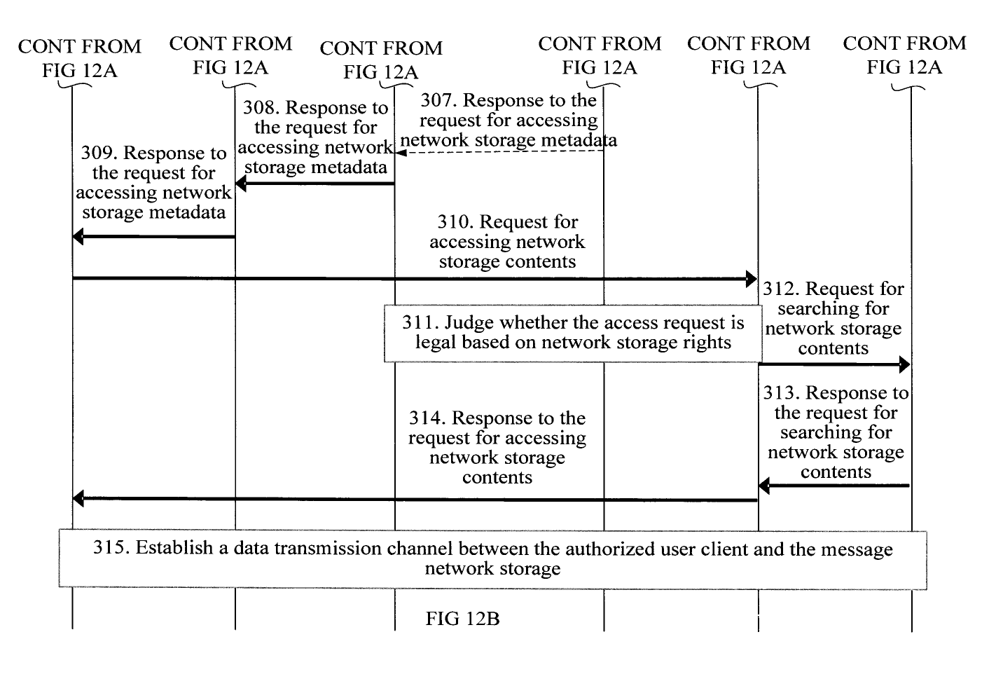

Through the preceding embodiments, the authorizing user may manage network storage rights of his/her network storages, so as to control a requesting user to access the network storages by using the network storage access rights that the authorizing user manages. A method for network storage access control is provided in the second embodiment. As shown in FIG. 12, the method may include the following steps:

S301. The requesting user sends a request for accessing network storage metadata, where the request carries network storage information to be accessed. The network storage information to be accessed includes related information of network storage directories or network storage metadata files associated with the network storages to be accessed, the ID of the authorizing user associated with the network storages to be accessed, and the ID of the requesting user.

S302a-S302b. The requesting user and the aggregation proxy perform bidirectional authentication. After the authentication succeeds, the aggregation proxy obtains the ID of the trustable requesting user.

If the requesting user and the network storages of the authorizing user are located in different network domains, the aggregation proxy may also support cross-domain access. That is, an aggregation proxy in a network domain where the requesting user is located routes the authenticated request to an aggregation proxy in a network domain where the authorizing user is located.

S303. The aggregation proxy sends a request for accessing network storage metadata to the message metadata server, where the request carries network storage information that the requesting user wants to access. The network storage information that the requesting user wants to access includes the ID of the requesting user, related information of network storage directories or network storage metadata files associated with the network storages to be accessed, and the ID of the authorizing user associated with the network storages to be accessed.

S304. After receiving the request for accessing network storage metadata, the network storage access controller in the message metadata server obtains storage access rights metadata that the authorizing user grants to the requesting user according to the ID of the authorizing user, related information of network storage directories or network storage metadata files, and the ID of the requesting user carried in the request. In addition, the network storage access controller authenticates the request for accessing network storage metadata from the requesting user according to the obtained storage access rights metadata. If the request is legal, the network storage access controller continues to execute S305; otherwise, it rejects the request for accessing network storage metadata.

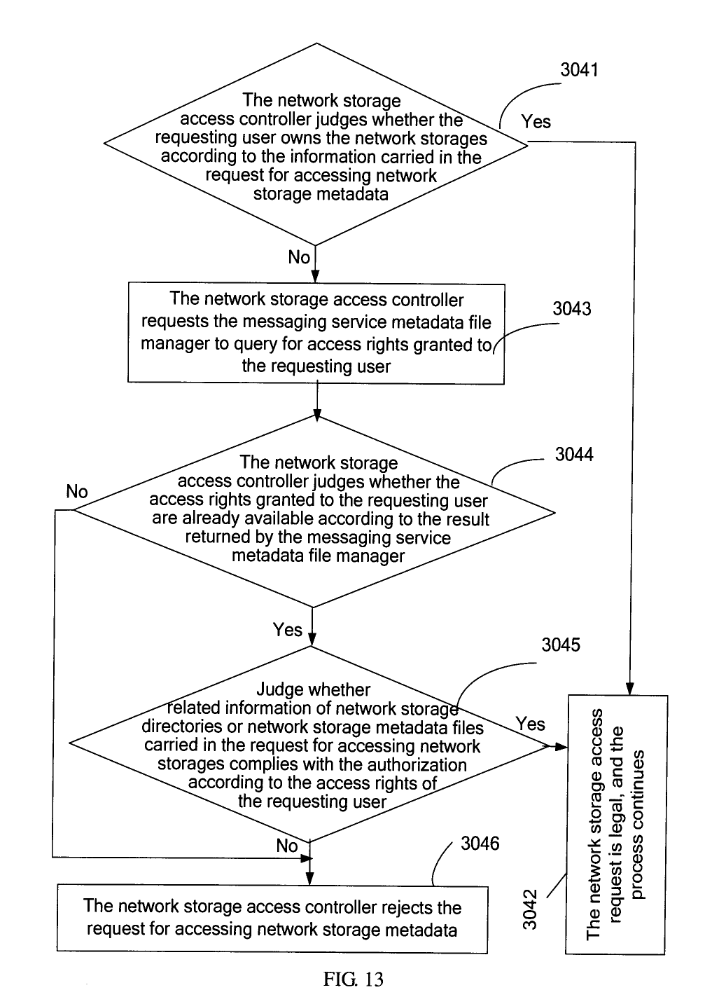

FIG. 13 shows a process of authenticating the request for accessing network storage metadata. The process may include the following steps:

S3041. The message metadata server judges whether the requesting user is the authorizing user according to the ID of the requesting user and ID of the authorizing user associated with the related information of network storage directories or network storage metadata files carried in the request. If so, the process goes to S3042, and then goes to S305; otherwise the process goes to S3043.

S3041-S3042. The network storage access controller in the message metadata server may find the ID of the authorizing user according to related information of network storage directories or network storage metadata files carried in the request. Then, the network storage access controller may compare the ID of the authorizing user with the ID of the requesting user carried in the request. If the two IDs are the same, the requesting user is an authorizing user; otherwise the requesting user is not an authorizing user.

S3043. The network storage access controller requests the messaging service metadata file manager to search for access rights that are granted to the requesting user, where the request carries the ID of the authorizing user, related information of network storage directories or network storage metadata files, and the ID of the requesting user.

The messaging service metadata file manager searches for storage access rights metadata associated with the ID of the requesting user according to the information carried in the request. This may be implemented by using the following two methods:

(1) Method Based on a Storage Authorization Policy

Search the storage authorization policy metadata file associated with the ID of the authorizing user, and search the storage authorization policy metadata associated with related information of network storage directories or network storage files for storage access rights associated with the ID of the requesting user.

(2) Method Based on a User Access Policy

Search the user access policy metadata file associated with the ID of the authorizing user, and search the user access rule metadata associated with related information of network storage directories or network storage files for the user access rule associated with the ID of the requesting user; if the user access rule is available, search the network storage metadata file associated with the user access rule for storage access rights associated with the ID of the requesting user.

S3044. The network storage access controller judges whether access rights that are granted to the requesting user are available according to the result returned by the messaging service metadata file manager. If so, the process goes to S3045; otherwise the process goes to S3046.

S3045. The network storage access controller judges whether related information of network storage directories or network storage metadata files carried in the network storage access request complies with the authorization according to the access rights that are granted to the requesting user; that is, the priority of the access rights of a file or directory required in the access request of the requesting user must be lower than or equal to the priority of rights of the file or directory that the requesting user already owns. If so, the process goes back to S3042; otherwise the process goes to S3046.

S3046. The network storage access controller rejects the request for accessing network storage metadata.

S305. The network storage access controller sends a legal request for accessing network storage metadata to the messaging service metadata file manager, where the request carries network storage information that the requesting user wants to access. The network storage information that the requesting user wants to access includes the ID of the requesting user, related information of network storage directories or network storage metadata files associated with the network storages to be accessed, and the ID of the authorizing user associated with the network storages to be accessed.

S306-S309. The messaging service metadata file manager obtains the network storage metadata according to related information of network storage directories or network storage metadata files carried in the request for accessing network storage metadata, responds to the request, and carries the obtained network storage metadata in the response.

S310. The requesting user obtains the network storage metadata according to the response, and sends a request for accessing network storage contents to the message server, where the request carries the network storage metadata and ID of the requesting user.

S311. The message server requests the message metadata server to authenticate the request for accessing network storage contents. If the request is legal, the message server continues to execute S312; if the request is illegal, the message server rejects the request for accessing network storage contents.

The specific authentication process is similar to that in S304, and will not be further described.

S312. The message server sends a network storage access request to a message content storage, where the request carries metadata associated with the requested messaging service network storages.

S313-S314. The message content storage searches for the messaging service network storages according to the metadata, and returns a network storage search response to the user client through the message server.

S315. The message content storage establishes a data transmission channel between the user client and the message content storage, through which the message content storage sends the searched messaging service network storage contents to the requesting user;

or requests the user client to upload the local messaging service storage contents to the message content storage.

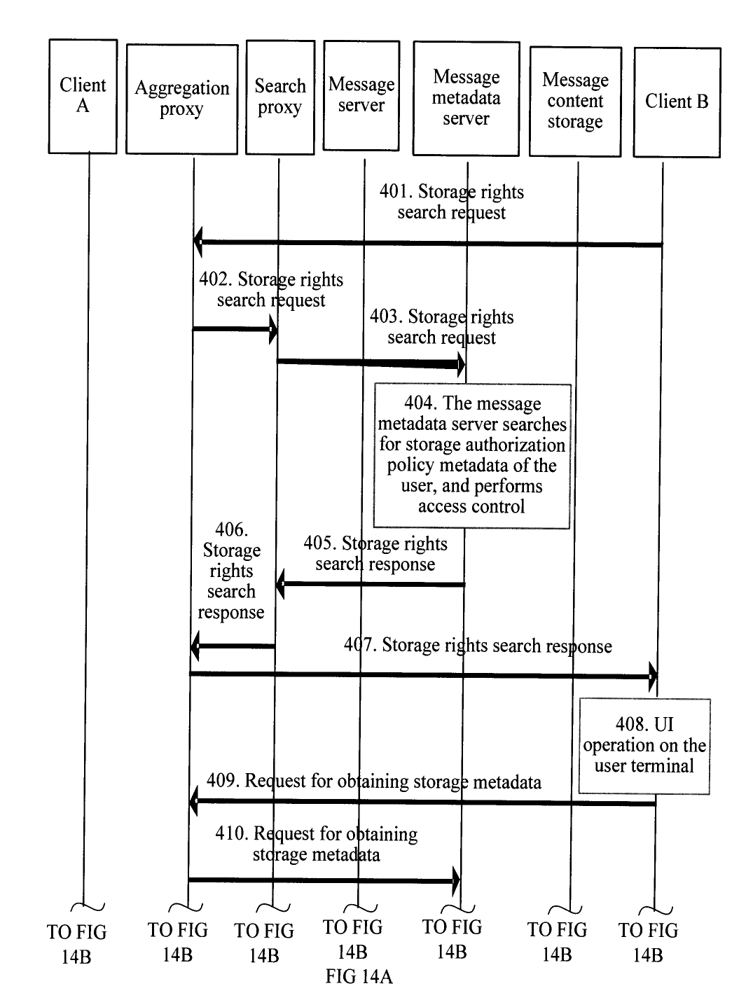

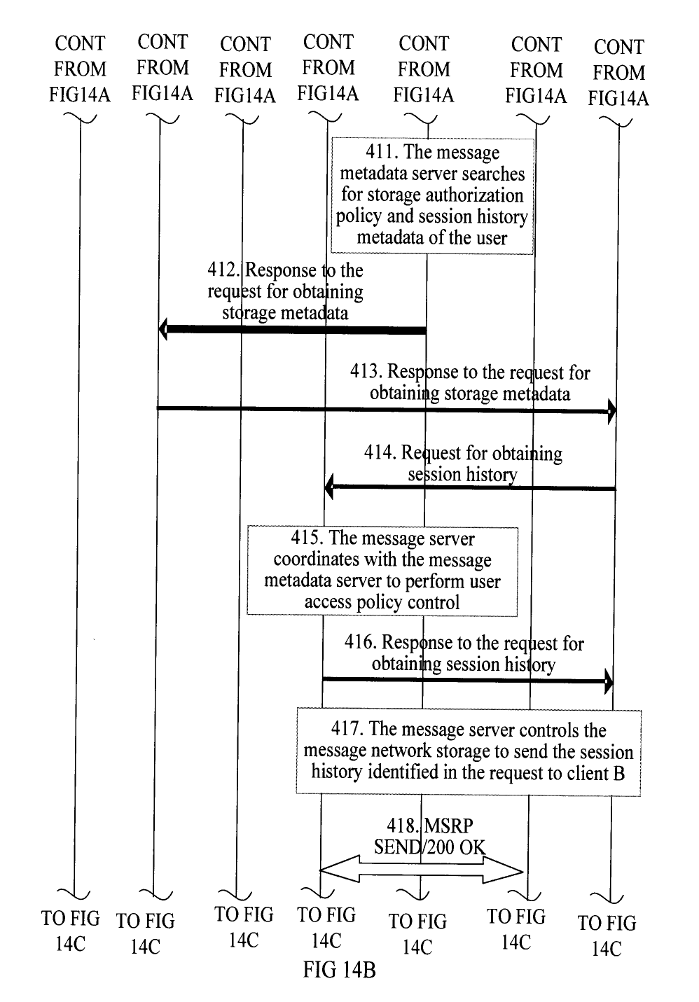

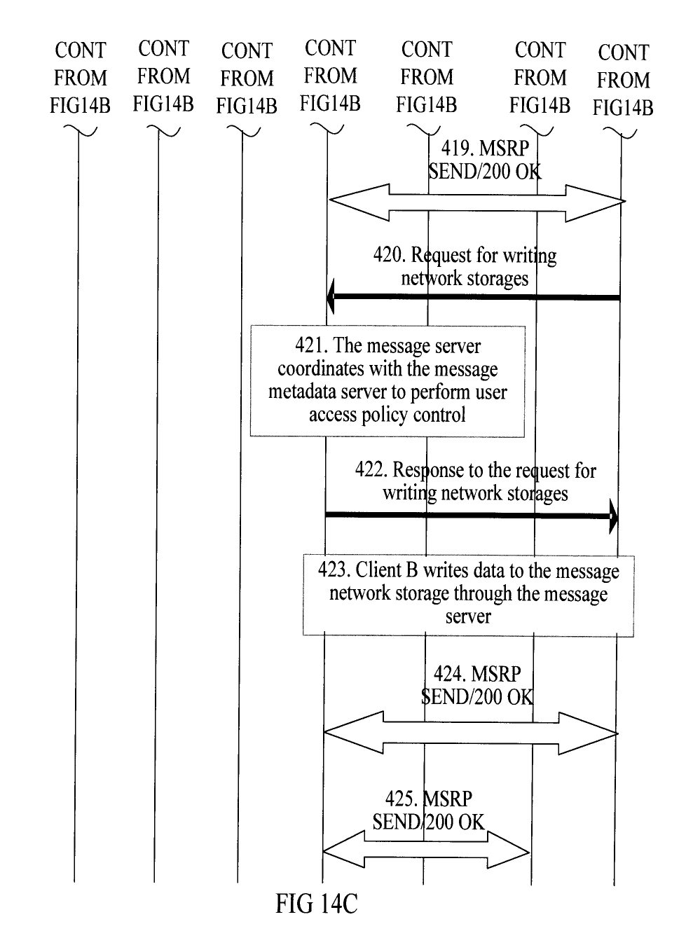

Supposing the authorizing user A grants read/write rights of a session history network storage directory to the requesting user B, the following describes the preceding process of accessing network storages in detail by taking the method based on a storage authorization policy as an example. As shown in FIG. 14, the process includes the following step:

S401-S403. The requesting user B (client B) wants to access network storages of the authorizing user A (client A). Thus, the user B may obtain the network storage rights that the user A grants to the user B. To do this, the user B sends an HTTP POST request to the message metadata server through the aggregation proxy and search proxy, where the request carries network storage information that the user B wants to access. The network storage information that the requesting user wants to access includes the ID of the requesting user, related information of network storage directories or network storage metadata files associated with the network storages to be accessed, and the ID of the authorizing user associated with the network storages to be accessed.

S404. The message metadata server searches for storage authorization policy metadata of the user B, and performs access control on the storage authorization policy metadata. The details are as follows:

The messaging service metadata file manager in the message metadata server, under the control of the network storage access controller, searches the storage authorization policy metadata file of the authorizing user A for storage authorization policy metadata associated with related information of network storage directories or network storage files according to the ID of the authorizing user and related information of network storage directories or network storage metadata files carried in the HTTP POST request. If the storage authorization policy metadata is already available, the messaging service metadata file manager searches the storage authorization policy metadata for storage access rights metadata associated with the ID of the user B. If the authorization information is available in the storage access rights metadata, the network storage access controller accepts the request, and executes S405; otherwise the network storage access controller rejects the request.

S405-S407. The network storage access controller responds to the network storage rights search request, and returns search results from the messaging service metadata file manager to the user B through the search proxy and aggregation proxy, where the search results carry network storage access rights that the authorizing user A grants to the user B.

S408-S410. The user B views the rights information of network storage directories or network storage metadata files that the authorizing user A grants to the user B on a terminal, and finds that the user B owns read/write rights of a session history network storage directory of the authorizing user A. To view the session history content in this directory, the user B sends a request (XCAP GET) for obtaining network storage metadata to the message metadata server through the aggregation proxy. The XCAP GET request carries network storage information that the user B wants to access. The network storage information that the user B wants to access may include the ID of the user B, related information of network storage directories or network storage files associated with a session history messaging service that the user B wants to access, and the ID of the authorizing user associated with the network storage to be accessed.

S411. After receiving the XCAP GET request, the message metadata server searches for storage authorization policy metadata and “session history” metadata of the user B, and performs related control.

The details are as follows:

The message metadata server searches the storage authorization policy metadata file of the authorizing user A for network storage access rights that the authorizing user A grants to the user B. This is similar to S404, and will not be further described.

After determining that the user B owns the network storage access rights of the authorizing user A, the network storage access controller combines the authorization information of the user B searched out by the messaging service metadata file manager.

The network storage access controller judges whether the access request of the user B complies with the authorization made by the authorizing user A to the user B according to the process of authenticating the request for accessing network storage metadata. The network storage access controller accepts legal network storage access requests only.

S412-S413. The message metadata server returns session history metadata information granted by the authorizing user A according to a response for obtaining network storage metadata, where the session history metadata information reaches the user B through the aggregation proxy.

S414. The user B browses the session history metadata information in the network storages of the authorizing user A. To obtain the actual session history contents, the user B client sends a request for obtaining network storage contents to a “message server”, for example, SIP INVITE, in which “Request-URI” indicates URIs of network storages, such as “history@hostname”. In addition, the user B sets the direction attribute to “a=recvonly” in an MIME SDP message body, which includes session history metadata information, such as URI List composed of message IDs (msg-id) in network storage directories.

S415-S419. After receiving the SIP INVITE request, the message server coordinates with the message metadata server in performing user access policy control and establishing a session history content transmission channel between the message content storage and the user B. In addition, the message server and the message metadata server transmit the session history contents in the message content storage to the user B through the transmission channel. The details are as follows:

The message server requests the network storage access controller in the message metadata server to perform access control similar to S404. If accepting the request of the user B, the message server returns a SIP 200 OK response to the user B, and establishes a session history content transmission channel between the message content storage and the user B after receiving another SIP ACK response from the user B, for example, a media channel over the Message Session Relay Protocol (MSRP channel). Now the user B may receive session history information in the network storages of the authorizing user A that is requested by and accessible to the user B through the transmission channel.

S420-S425. Because the user B owns the write right of the session history network storage directory granted by the user A, the user B may upload the local data to the directory besides obtaining the session history of the authorizing user A in the directory. Thus, the user B sends a request for uploading network storage contents to the message server, for example SIP INVITE, in which “Request-URI” indicates the URI where the message network storage entity is located, such as “history@ hostname”. In addition, the user B sets the direction attribute to “a=sendonly” in the MIME SDP message body, which includes network storages of the user A where the uploaded data is stored, for example, IDs of network storage directories or file-names of session history files.

The message server requests the message metadata server to perform access policy control similar to S404. Once accepting the request of the user B, the message server establishes a data transmission channel between the message content storage and the user B. Now the user B may upload the local data to the network storages of the authorizing user A of which the user B owns the write right through the established data transmission channel, for example, the MSRP channel.

After the data transmission succeeds, the message server may also request the message metadata server to update the messaging service metadata information of the authorizing user A to reflect the added data in the network storages of the authorizing user A.

The authorizing user A receives a notification of network storage changes after the user B writes data to the message content storage of the authorizing user A successfully, which is similar to the notification process shown in FIG. 8 to FIG. 11.

What has been described is based on the assumption that the storage access rights information carried in the request includes the ID of at least one authorizing user with access rights. When the storage access rights information includes the ID of at least one authorizing user who is forbidden to obtain access rights, operations are performed as follows:

I. Granting Network Storage Access Rights

Search the storage authorization policy metadata file of the authorizing user, and create storage access rights metadata associated with the ID of a user who is forbidden to obtain access rights in the storage authorization policy metadata associated with related information of the network storage directories or network storage files according to the storage access rights information carried in the request; or

Search a user access policy metadata file associated with the ID of the authorizing user, and create user access rules associated with the ID of the authorized user in the user access rule metadata associated with related information of network storage directories or network storage files in the user access policy metadata file; in addition, create storage access rights metadata associated with the ID of a user who is forbidden to obtain access rights in the network storage metadata file associated with the user access rule according to the storage access rights information carried in the request.

II. Updating Network Storage Access Rights

Search a storage authorization policy metadata file associated with the ID of the authorizing user, and change storage access rights metadata associated with the ID of a user who is forbidden to obtain access rights in the storage authorization policy metadata associated with related information of network storage directories or network storage files involved in the storage access rights information that the authorizing user requests to operate according to the storage access rights information carried in the request; or

Search for a user access rule associated with the ID of the user who is forbidden to obtain access rights in the user access rule metadata associated with related information of network storage directories or network storage files involved in the storage access rights information that the authorizing user requests to operate in the user access policy metadata file associated with the ID of the authorizing user; furthermore, change the storage access rights metadata associated with the ID of the user who is forbidden to obtain access rights in the network storage metadata file associated with the user access rule according to the storage access rights information carried in request.

III. Withdrawing Network Storage Access Rights

Search a storage authorization policy metadata file associated with the ID of the authorizing user, and delete storage access rights metadata associated with the ID of a user who is forbidden to obtain access rights in the storage authorization policy metadata associated with related information of network storage directories or network storage files involved in the storage access rights information that the authorizing user requests to operate according to the storage access rights information carried in the request; or

Search a user access policy metadata file associated with the ID of the authorizing user, and delete the user access rule associated with the ID of a user who is forbidden to obtain access rights in the user access rule metadata associated with related information of network storage directories or network storage files involved in the storage access rights information that the authorizing user requests to operate in the user access policy metadata file associated with the ID of the authorizing user; in addition, delete the storage access rights metadata associated with the ID of the user who is forbidden to obtain access rights in the network storage metadata file associated with the deleted user access rule according to the storage access rights information carried in the request.

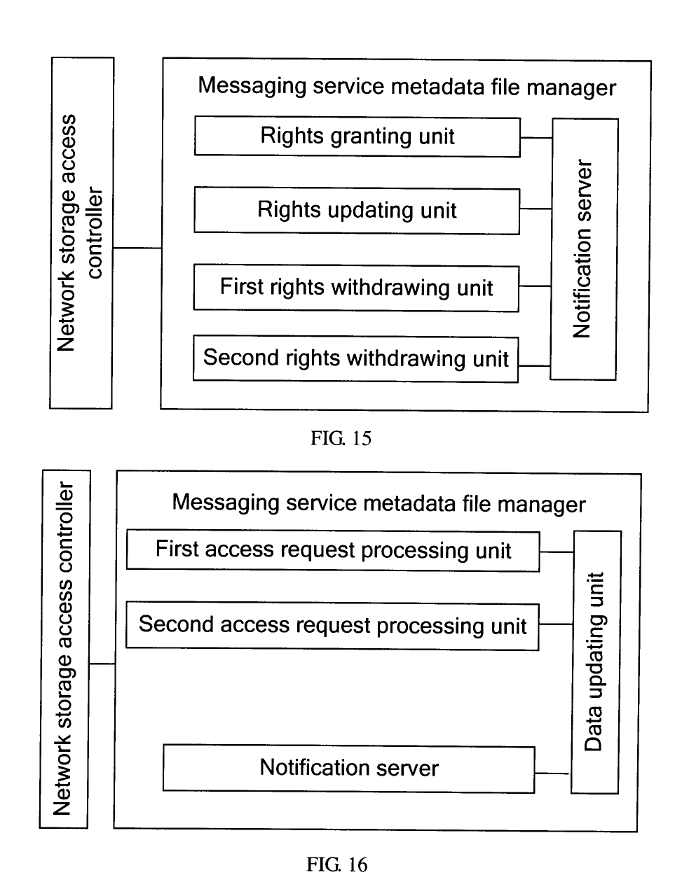

The third embodiment provides an apparatus for network storage access rights management. As shown in FIG. 15, the apparatus may include a network storage access controller and a messaging service metadata file manager. The network storage access controller and the messaging service metadata file manager may include a rights granting unit, a rights updating unit, and a first rights withdrawing unit. The rights granting unit may include a first rights granting subunit and a second rights granting subunit. The rights updating unit may include a first rights updating subunit and a second rights updating subunit. The first rights withdrawing unit may include a first rights withdrawing subunit and a second rights withdrawing subunit.

The messaging service metadata file manager may further include a second rights withdrawing unit. The second rights withdrawing unit may include a third rights withdrawing subunit and a fourth rights withdrawing subunit.

The messaging service metadata file manager may further include a notification server.

The following describes the interactive relation between components in the apparatus for network storage access rights management:

The network storage access controller is configured to: obtain a request for operating network storage access rights of an authorizing user, where the request carries storage access rights information that the authorizing user requests to operate, where the storage access rights information includes the ID of the authorizing user, related information of network storage directories or network storage files involved in the storage access rights information, and the ID of at least one authorized user or a user who is forbidden to obtain access rights; and authenticate the request for operating network storage access rights of the authorizing user according to the storage access rights information in the messaging service metadata file manager.

The messaging service metadata file manager is configured to: operate storage access rights that the authorizing user sets for the authorized user in the network storage access rights metadata of the authorizing user associated with the ID of the authorizing user and related information of network storage directories or network storage files according to the request for operating network storage access rights authenticated by the network storage access controller. The messaging service metadata file manager performs related operations according to different requests for operating network storage access rights. The details are as follows:

Through the rights granting unit, the messaging service metadata file manager grants related storage access rights metadata to the authorized user according to the storage access rights that the authorizing user requests to grant in the network storage access rights metadata file associated with the ID of the authorizing user and related information of network storage directories or network storage files according to the request for operating network storage access rights obtained by the network storage access controller. Two solutions, for example, may be available for this operation:

In the first solution, the messaging service metadata file manager searches the storage authorization policy metadata file associated with the ID of the authorizing user through the first rights granting subunit, and creates storage access rights metadata associated with the ID of the authorized user in the storage authorization policy metadata associated with related information of network storage directories or network storage files involved in the storage access rights information that the authorizing user requests to operate according to the storage access rights information carried in the request; or the messaging service metadata file manager searches the storage authorization policy file of the authorizing user, and creates storage access rights metadata associated with the ID of a user who is forbidden to obtain access rights in the storage authorization policy metadata associated with related information of network storage directories or network storage files involved in the storage access rights information that the authorizing user requests to operate according to the storage access rights information carried in the request.

In the second solution, the messaging service metadata file manager searches the user access policy metadata file associated with the ID of the authorizing user through the second rights granting subunit, and creates a user access rule associated with the ID of the authorized user in the user access rule metadata associated with related information of network storage directories or network storage files involved in the storage access rights information that the authorizing user requests to operate. In addition, the messaging service metadata file manager creates storage access rights metadata associated with the ID of the authorized user in the network storage metadata file associated with the user access rule according to the storage access rights information carried in the request; or the messaging service metadata file manager searches the user access policy metadata file associated with the ID of the authorizing user through the second rights granting subunit, and creates a user access rule associated with the ID of the authorized user in the user access rule metadata associated with related information of network storage directories or network storage files involved in the storage access rights information that the authorizing user requests to operate. In addition, the messaging service metadata file manager creates storage access rights metadata associated with the ID of a user who is forbidden to obtain access rights in the network storage metadata file associated with the user access rule according to the storage access rights information carried in the request.

Through the rights updating unit, the messaging service metadata file manager changes the storage access rights metadata that the authorizing user sets for the authorized user according to the storage access rights information that the authorizing user requests to update in the network storage access rights metadata file associated with the ID of the authorizing user and related information of network storage directories or network storage files according to the request for operating network storage access rights obtained by the network storage access controller. Two solutions, for example, may be available for this operation.

In the first solution, the messaging service metadata file manager searches the storage authorization policy metadata file associated with the ID of the authorizing user through the first rights updating subunit, and changes the storage access rights metadata associated with the ID of the authorized user in the storage authorization policy metadata associated with related information of network storage directories or network storage files according to the storage access rights information carried in the request; or the messaging service metadata file manager searches the storage authorization policy metadata file associated with the ID of the authorizing user, and changes the storage access rights metadata associated with the ID of a user who is forbidden to obtain access rights in the storage authorization policy metadata associated with related information of network storage directories or network storage files according to the storage access rights information carried in the request.

In the second solution, the messaging service metadata file manager searches the user access policy metadata file associated with the ID of the authorizing user for user access rule metadata associated with related information of network storage directories or network storage files through the second rights updating subunit, obtains the user access rule associated with the ID of the authorized user, and changes the storage access rights metadata associated with the ID of the authorized user in the network storage metadata file associated with the user access rule or network storage metadata file associated with related network storage directories according to the storage access rights information carried in the request; or the messaging service metadata file manager searches the user access rule metadata associated with related information of network storage directories or network storage files in the user access policy metadata file associated with the ID of the authorizing user for a user access rule associated with the ID of a user who is forbidden to obtain access rights, and changes the storage access rights metadata associated with the ID of the user who is forbidden to obtain access rights in the network storage metadata file associated with the user access rule or network storage metadata file associated with related network storage directories according to the storage access rights information carried in the request.

Through the first rights withdrawing unit, the messaging service metadata file manager deletes the storage access rights metadata that the authorizing user sets for the authorized user according to the storage access rights that the authorizing user requests to withdraw in the network storage access rights metadata file associated with the ID of the authorizing user and related information of network storage directories or network storage files according to the request for operating network storage access rights obtained by the network storage access controller. Two solutions, for example, may be available for this operation:

In the first solution, the messaging service metadata file manager searches the storage authorization policy metadata file associated with the ID of the authorizing user through the first rights withdrawing subunit, and deletes the storage access rights metadata associated with the ID of the authorized user in the storage authorization policy metadata associated with related information of network storage directories or network storage files according to the storage access rights information carried in the request; or the messaging service metadata file manager searches the storage authorization policy metadata file associated with the ID of the authorizing user, and deletes the storage access rights metadata associated with the ID of a user who is forbidden to obtain access rights in the storage authorization policy metadata associated with related information of network storage directories or network storage files according to the storage access rights information carried in the request.

In the second solution, the messaging service metadata file manager searches the user access policy metadata file associated with the ID of the authorizing user through the second rights withdrawing subunit, deletes the user access rule associated with the ID of the authorized user in the user access rule metadata associated with related information of network storage directories or network storage files, and deletes the storage access rights metadata associated with the ID of the authorized user in the network storage metadata file associated with the deleted user access rule or network storage metadata file associated with related network storage directories according to the storage access rights information carried in the request; or the messaging service metadata file manager searches the user access policy metadata file associated with the ID of the authorizing user, deletes the user access rule associated with the ID of a user who is forbidden to obtain access rights in the user access rule metadata associated with related information of network storage directories or network storage files, and deletes the storage access rights metadata associated with the ID of the user who is forbidden to obtain access rights in network storage metadata files associated with the deleted user access rule or in network storage metadata files associated with related network storage directories.

In addition, the messaging service metadata file manager may also delete the storage access rights metadata associated with the authorizing user through the second rights withdrawing unit when the expiration date of storage access rights of network storage directories or network storage files that the authorizing user sets for the authorized user is due. Two solutions, for example, may be available for this operation:

In the first solution, the messaging service metadata file manager deletes the storage access rights metadata in the storage authorization policy metadata file associated with the ID of the authorizing user through the third rights withdrawing subunit when the expiration date of the storage access rights metadata associated with an authorized user is due.

In the second solution, the messaging service metadata file manager deletes the storage access rights metadata in network storage files associated with the ID of the authorizing user or network storage files in network storage directories associated with the ID of the authorizing user through the fourth rights withdrawing subunit when the expiration date of the storage access rights metadata associated with the ID of an authorized user is due. In addition, the messaging service metadata file manager deletes the user access rule metadata associated with the storage access rights metadata in the user access policy metadata file associated with the ID of the authorizing user.

In addition, once the metadata in the messaging service metadata file manager is changed, the message metadata server may also notify the changed metadata. This may be implemented as follows:

After operating the storage access rights of network storage directories or network storage files of the authorizing user according to the request for operating network storage access rights of the authorizing user, the message metadata server notifies the authorized user associated with the network storage access rights metadata of changed network storage access rights metadata through the notification server; or when the expiration date of storage access rights of network storage directories or network storage files that the authorizing user sets for the authorized user is due, the message metadata server notifies the authorized user associated with the network storage access rights metadata of changed network storage access rights metadata.

When the notification server notifies the authorized user of changed storage access rights metadata, it may also notify the authorized user of available access modes.

The fourth embodiment provides an apparatus for network storage access rights management. As shown in FIG. 16, the apparatus includes a network storage access controller and a messaging service metadata file manager.

The messaging service metadata file manager includes a first access request processing unit and a second access request processing unit.

The messaging service metadata file manager may further include a data updating unit.

The messaging service metadata file manager may further include a notification server.

The following describes the interactive relation between components in the apparatus for network storage access rights management:

When an authorized user accesses network storages of an authorizing user, the network storage access controller obtains a request for accessing network storage directories or network storage files of the authorizing user from the authorized user, where the request carries the ID of the authorized user, the ID of the authorizing user, and related information of network storage directories or network storage files that the authorized user requests to access. Then, the network storage access controller requests storage access rights information associated with the ID of the authorized user from the messaging service metadata file manager.

In this case, the messaging service metadata file manager provides the network storage access controller with storage access rights information associated with the ID of the authorized user in the network storage access rights metadata associated with the authorizing user.

The network storage access controller obtains storage access rights information associated with the ID of the authorized user in the network storage access rights metadata associated with the authorizing user from the messaging service metadata file manager according to the information returned by the messaging service metadata file manager. The network storage access controller authenticates the access request of the authorized user by using the storage access rights information, and requests metadata accessible to the authorized user from the messaging service metadata file manager.

In this case, the messaging service metadata file manager provides the network storage access controller with metadata accessible to the authorized user in network storage files or network storage files in network storage directories associated with the authorizing user. Two solutions, for example, may be available for this operation:

In the first solution, through the first request processing unit, the messaging service metadata file manager searches the storage authorization policy metadata file associated with the ID of the authorizing user for storage authorization policy metadata associated with related information of network storage directories or network storage files, and obtains the storage access rights metadata associated with the ID of the authorized user. Then, the messaging service metadata file manager returns the metadata of network storage directories or network storage files associated with the storage access rights metadata to the network storage access controller.

In the second solution, through the second request processing unit, the messaging service metadata file manager searches the user access policy metadata file associated with the ID of the authorizing user for user access policy metadata associated with related information of network storage directories or network storage files, and obtains the user access rule associated with the ID of the authorized user. Then, the messaging service metadata file manager obtains storage access rights metadata associated with the ID of the authorized user in the network storage metadata files or network storage metadata files associated with the network storage directories according to the user access rule, and returns the metadata of network storage directories or network storage files associated with the storage access rights metadata to the network storage access controller.

The network storage access controller provides the authorized user with metadata returned by the messaging service metadata file manager.

The network storage access controller obtains a request for accessing network storage message contents associated with the metadata from the authorized user, where the request carries the ID of the authorized user, the ID of the authorizing user, and metadata associated with the network storage message contents of the authorizing user that the authorized user requests to access. The network storage access controller requests storage access rights information associated with the ID of the authorized user in the network storage access rights metadata associated with the authorizing user from the messaging service metadata file manager to authenticate the request. After the request passes the authentication, the network storage access controller provides the message server with metadata accessible to the authorized user in the network storage metadata file of the authorizing user or network storage metadata file associated with network storage directories, and requests message contents associated with the metadata accessible to the authorized user from the message content storage through the message server.

Then, the messaging service metadata file manager establishes a data transmission channel between the message content storage and the authorized user through interactive control between the message server and the core network. The authorized user may upload or read message contents through the data transmission channel.

For the message contents uploaded by the authorized user, the messaging service metadata file manager adds, changes or deletes information of network storage message contents of the authorizing user in the message content storage under the control of the message server. Then, the message server sends a request to control the messaging service metadata file manager to update the metadata of network storage directories or network storage files of the authorizing user according to the changed information.

The messaging service metadata file manager obtains the request from the message server through the data updating unit, where the request carries information after the network storage contents of the authorizing user are added, changed or deleted in the message content storage according to the message contents uploaded by the authorized user. The data updating unit updates the metadata of the network storage directories or network storage files of the authorizing user according to the changed information.

In addition, once the metadata in the messaging service metadata file manager is changed, the message metadata server may also notify the changed metadata. This may be implemented as follows:

After updating the metadata information in network storage files of the authorizing user or network storage files associated with the network storage directories according to the message contents uploaded by the authorized user, the messaging service metadata file manager notifies the authoring user and/or an authorized user who owns access rights of network storage directories and/or network storage files of changed metadata.

When the notification server notifies the authorized user of changed storage access rights metadata, it may also notify the authorized user of available access modes.

The preceding embodiments operate storage access rights of network storage directories or network storage files that the authorizing user sets for the authorized user in the network storage access rights metadata of the authorizing user according to the storage access rights information that the authorizing user requests to operate, so that the authorized user is allowed to access network storages of the authorizing user.

Although the disclosure has been described through some exemplary embodiments, the disclosure is not limited to such embodiments. It is apparent that those skilled in the art can make various modifications and variations to the disclosure without departing from the spirit and scope of the embodiments. The disclosure is intended to cover these modifications and variations provided that they fall in the scope of protection defined by the following claims or their equivalents.

What is claimed is:

1. A method for network storage access rights management, comprising:
obtaining a request for operating network storage access rights from an authorizing user, wherein the request carries storage access rights information that the authorizing user requests to operate; and
operating storage access rights of network storage directories or network storage files that the authorizing user sets for an authorized user in network storage access rights metadata of the authorizing user according to the storage access rights information.

2. The method of claim 1, further comprising:
classifying messaging service metadata in a same application usage according to attributes of messaging services;
creating a network storage directory for each type of metadata, and associating the network storage directories with the network storage files that store the metadata.

3. The method of claim 2, wherein the network storage directories further comprise lower-level network storage directories created for lower-level data of each type of metadata.

4. The method of claim 1, wherein the storage access rights information that the user requests to operate comprises:
an identification (ID) of at least one authorized user who obtains the access rights or at least one user who is forbidden to obtain the access rights and related information of network storage directories or network storage files involved in the storage access rights information.

5. The method of claim 4, wherein the storage access rights information further comprises at least one of the following: access rights of the network storage files or network storage directories, inheritance attributes of the access rights of the network storage files or network storage directories, lock attributes of the access rights of the network storage files or network storage directories, expiration date of the access rights of the network storage files or network storage directories, and granting date of the access rights of the network storage files or network storage directories.

6. The method of claim 1, wherein operating the storage access rights according to the storage access rights information comprises:
searching a storage authorization policy metadata file of the authorizing user, and creating, changing, or deleting storage access rights metadata associated with the ID of the authorized user or the user who is forbidden to obtain access rights in the storage authorization policy metadata associated with the related information of network storage directories or network storage files according to the storage access rights information carried in the request.

7. The method of claim 1, wherein operating the storage access rights according to the storage access rights information comprises:
searching a user access policy metadata file associated with the authorizing user, and creating or deleting user access rules associated with the ID of the authorized user or the user who is forbidden to obtain access rights in the user access rule metadata associated with the related information of network storage directories or network storage files; and creating or deleting storage access rights metadata associated with the ID of the authorized user or the user who is forbidden to obtain access rights in the network storage metadata files associated with the user access rules according to the storage access rights information carried in the request.

8. The method of claim 1, wherein operating the storage access rights according to the storage access rights information comprises:
searching a user access policy metadata file associated with the authorizing user for user access rules associated with the ID of the authorized user or the user who is forbidden to obtain access rights in the user access rule metadata associated with the related information of network storage directories or network storage files; and changing storage access rights metadata associated with the ID of the authorized user or the user who is forbidden to obtain access rights in the network storage metadata files associated with the user access rules according to the storage access rights information carried in the request.

9. The method of claim 1, further comprising:
deleting the storage access rights metadata from a storage authorization policy metadata file of the authorizing user when the expiration date of the storage access rights metadata associated with the ID of the authorized user is due.

10. The method of claim 1, further comprising:
deleting the storage access rights metadata from the storage access rights metadata file of the authorizing user when the expiration date of the storage access rights metadata associated with the ID of the authorized user is due; and deleting the user access rule metadata associated with the storage access rights of the authorized user from a user access policy metadata file of the authorizing user.

11. The method of claim 1, further comprising:
notifying the authorized user associated with the network storage access rights metadata of the changed network storage access rights metadata.

12. The method of claim 11, wherein the authorized user is notified of available access modes when notified of the changed storage access rights metadata.

13. A method for network storage access control, comprising:
obtaining a request for accessing network storages of an authorizing user from an authorized user; and
providing the authorized user with metadata accessible to the authorized user in network storage metadata files of the authorizing user according to storage access rights information of the authorized user in network storage access rights metadata of the authorizing user.

14. The method of claim 13, wherein the process of providing the authorized user with metadata accessible to the authorized user in network storage metadata files of the authorizing user according to the storage access rights information of the authorized user in the network storage access rights metadata of the authorizing user comprises:
searching a storage authorization policy metadata file of the authorizing user for storage authorization policy metadata associated with the network storage directories or network storage files of the authorizing user accessible to the authorized user, obtaining storage access rights metadata associated with the ID of the authorized user, and providing the authorized user with the metadata of network storage directories or network storage files associated with the storage access rights metadata.

15. The method of claim 13, wherein the process of providing the authorized user with metadata accessible to the authorized user in network storage metadata files of the authorizing user according to the storage access rights information of the authorized user in the network storage access rights metadata of the authorizing user comprises:
searching a user access policy metadata file of the authorizing user for user access rule metadata associated with related information of network storage directories or network storage files of the authorizing user accessible to the authorized user, and obtaining user access rules associated with the ID of the authorized user; obtaining the storage access rights metadata associated with the ID of the authorized user in a network storage access rights metadata file according to the user access rules; and providing the authorized user with metadata of network storage directories or network storage files associated with the storage access rights metadata.

16. The method of claim 13, further comprising:
obtaining a request for accessing network storages associated with the network storage metadata of the authorizing user from the authorized user; and
authenticating the access request from the authorized user according to the storage access rights information of the authorized user in the network storage access rights metadata of the authorizing user; establishing a data transmission channel between the authorized user who passes the authentication and network storages of the authorizing user, and performing data transmission between the authorized user and the network storages of the authorizing user through the data transmission channel.

17. The method of claim 16, further comprising:
obtaining message contents uploaded by the authorized user by using the data transmission channel; adding, changing or deleting network storage contents of the authorizing user according to the uploaded message contents, and updating the metadata of network storage directories or network storage files of the authorizing user according to changed information.

18. The method of claim 17, further comprising:
after updating the metadata of the network storage directories or network storage files of the authorizing user according to the message contents uploaded by the authorized user, notifying the authorizing user or the authorized user who has rights to access the network storage directories or network storage files of changed metadata.

19. An apparatus for network storage access rights management, comprising a network storage access controller and a messaging service metadata file manager, wherein:
the network storage access controller is configured to: obtain a request for operating network storage access rights from an authorizing user, wherein the request carries the storage access rights information that the authorizing user requests to operate, and authenticate the request for operating network storage access rights from the authorizing user according to the storage access rights information in the messaging service metadata file manager; and
the messaging service metadata file manager is configured to: based on the request for operating network storage access rights authenticated by the network storage access controller, operate storage access rights of network storage directories or network storage files that the authorizing user sets for an authorized user in network storage access rights metadata of the authorizing user according to the storage access rights information that the authorizing user requests to operate.

20. The apparatus of claim 19, wherein the messaging service metadata file manager further comprises:
a second rights withdrawing unit, configured to delete storage access rights metadata associated with the ID of the authorized user from the network storage access rights metadata file of the authorizing user when the expiration date of the storage access rights of the network storage directories or network storage files that the authorizing user sets for the authorized user is due.

21. An apparatus for network storage access rights management, comprising a network storage access controller and a messaging service metadata file manager, wherein:
the network storage access controller is configured to: obtain a request for accessing network storages of an authorizing user from an authorized user; authenticate the access request of the authorized user according to storage access rights information of the authorized user in network storage access rights metadata of the authorizing user in the messaging service metadata file manager; request metadata accessible to the authorized user from the messaging service metadata file manager if the authentication succeeds, and provide the authorized user with metadata returned by the messaging service metadata file manager; and
the messaging service metadata file manager is configured to return the storage access rights information of the authorized user in the network storage access rights metadata of the authorizing user to the network storage access controller.

22. The apparatus of claim 21, wherein the messaging service metadata file manager comprises:
a first request processing unit, configured to: search a storage authorization policy metadata file of the authorizing user for storage authorization policy metadata associated with related information of network storage directories or network storage files of the authorizing user accessible to the authorized user, and obtain storage access rights metadata associated with the ID of the authorized user; and return the metadata of network storage directories or network storage files associated with the storage access rights metadata to the network storage access controller.

23. The apparatus of claim 21, wherein the messaging service metadata file manager comprises:
a second request processing unit, configured to: search a user access policy metadata file of the authorizing user for user access rule metadata associated with related information of network storage directories or network storage files of the authorizing user accessible to the authorized user, and obtain user access rules associated with the ID of the authorized user; obtain storage access rights metadata associated with the ID of the authorized user in network storage metadata files according to the user access rules; and return the metadata of network storage directories or network storage files associated with the storage access rights metadata to the network storage access controller.

24. The apparatus of claim 21, wherein the network storage access controller is further configured to:
provide a message server with the metadata accessible to the authorized user in the network storage metadata files of the authorizing user for the authenticated access request; and obtain message contents of the metadata accessible to the authorized user that the message server requests from a message content storage according to the metadata, and provide the obtained message contents for the authorized user.

25. The apparatus of claim 24, wherein the messaging service metadata file manager further comprises:
a data updating unit, configured to: obtain a request from the message server, wherein the request carries message contents uploaded by the authorized user, and add, change or delete the network storage contents of the authorizing user; and update metadata of the network storage directories or network storage files of the authorizing user according to the changed information.

26. The apparatus of claim 24, further comprising:
a notification server, configured to: after the metadata of the network storage directories or network storage files of the authorizing user is updated according to the message contents uploaded by the authorized user, notify the authorizing user or the authorized user who has rights to access the network storage directories or network storage files of changed metadata.
